(19) United States
(12) Patent Application Publication
(10) Pub. No.: US 2007/0253009 A1
(43) Pub. Date: Nov. 1, 2007

(54) USER GENERATED TONAL REPRODUCTION CURVE (TRC) CONTROL FOR MONOCHROME PRINTERS

(75) Inventors: Richard T. HORN, Claremont, CA (US); Alexandra D. RUEGG, La Crescenta, CA (US)

Correspondence Address: OLIFF & BERRIDGE, PLC., P.O. BOX 19928, ALEXANDRIA, VA, 22320, US

(73) Assignee: XEROX CORPORATION, Stamford, CT (US)

(21) Appl. No.: 11/459,141

(22) Filed: Jul. 21, 2006

Related U.S. Application Data
(60) Provisional application No. 60/745,942, filed on Apr. 28, 2006.

(51) Int. Cl. G06F 15/00

(52) U.S. Cl. 358/1.9; 358/3.09

(57) ABSTRACT

A tool to create a TRC (Tonal Reproduction Curve) file on an monochrome image formation device that relates “input” grayscale values of a source file and the desired “output” (printed) grayscale values. By adjusting this curve, i.e., mapping selected input values to new output values, the file will be reproduced with tonal ranges which have been broadened and/or compressed as appropriate. The TRC is applied when the desired print file is released for reproduction thereby allowing the user to choose a desired curve at a print queue level to adjust each print file as desired. The adjustments remap what the decomposer would normally produce to a more appropriate range of tonal variations to emphasize image characteristics and value.

### BACKGROUND

The present disclosure relates to systems and methods for improving the print quality of monochromatic images. More particularly, the present disclosure relates to devices and methods for creating and implementing a Tonal Reproduction Curve (TRC) to improve the perception of shades of gray to make printed images more discernable and appealing upon viewing.

Monochromatic printers have traditionally had limited control of image output. For example, many print managers only allow for an increase and decrease of overall darkness without regard to graphics or text. In such cases, the entire printed page is lightened or darkened regardless of the print queue or type of Page Description Language (PDL) used.

Print fulfillment companies such as a service bureau or graphic communications company, receive files to print from many different customers using different applications. These files often include instructions for creating print pages that require embedded images, Because these embedded images come from many different sources, image quality varies as to lightness, darkness, and tonal range. If the source files are unavailable from the customer for adjustment and the file is printed without correction, the results are often dull and disappointing with much of the detail lost. Lightness/darkness can be adjusted to some extent on the printer but adjusting the tonal range of such images that often look flat, due to little or no tonal range, or due to bright “hot spots” from sharp tonal irregularities, has heretofore not been possible in monochrome printing.

Standard printer settings usually provide customers with the ability to change both the printed lines per inch (halftone screen) and the darkness level. In most cases this process produces acceptable print quality for the customer. However, in some cases, additional tools are required to ensure that fine detail is not lost in low contrast transitions. One such tool is a TRC.

A “Color Toolkit” for creating TRCs as part of a standard color printer software deliverable is known. For example Xerox Corporation offers a “Color Toolkit” for use on image formation systems that can reproduce color images. This toolkit is integrated at the queue level and enables a user to choose a specific halftone pattern to jobs passing through that queue. The toolkit also provides the user an interactive tool with which a “User TRC” curve can be created. The user can create User TRCs to make and save color adjustments that can be applied to jobs. For example, a user can create a TRC that compensates for jobs submitted from a specific device that generates a consistent magenta tint. A TRC adjusting for such off-color tint reproduction could be created and applied to every job submitted from the that device. Implementation of such TRCs saves job preparation time and assures that the same adjustment is made to all jobs submitted from that device.

User TRCs provide the skilled user with a tool for adjusting the individual CMYK color separations in an image and saving those adjustments for use on other images. However, no such toolkit exists for image enhancement on monochromatic image formation systems.

### SUMMARY

Despite the various known designs for controlling image output of printers, there remains a need in the art for devices and methods to improve image enhancement by improving the perception of shades of gray to make monochromatic printed images more discernable and appealing upon viewing.

The present disclosure addresses these and other needs by providing the tools to create and implement a Tonal Reproduction Curve (TRC) to allow monochromatic printer users to exercise greater control over the monochromatic image output of a printer. In an embodiment, the image quality of graphic images in a PDL document, such as a PostScript™ document, can be affected without changing the appearance of printed black text. By expanding and shifting the contrast range through a TRC, graphics with a limited darkness range and contrast, which would otherwise appear dull and disappointing to a viewer, look sharper and therefore better communicate their content to a viewer.

The present disclosure provides the user with a tool to create a TRC file on an monochrome printer that relates “input” grayscale values of a source file and the desired “output” (printed) grayscale values. By adjusting this curve, i.e., mapping selected input values to new output values, the file will be printed with tonal ranges which have been broadened and/or compressed as appropriate. The TRC is applied when the desired print file is released for printing thereby allowing the user to choose a desired curve at a print queue level to adjust each print file as desired. In an embodiment, the adjustments will be applied to objects in the file that rely on a PDL decomposer, such as PostScript™ decomposer, to produce a halftone pattern to simulate a shade of gray. The adjustments remap what the decomposer would normally produce to a more appropriate range of tonal variations to emphasize image characteristics and value.

### BRIEF DESCRIPTION OF THE DRAWINGS

These and other advantages and features of this disclosure will be apparent from the following, especially when considered with the accompanying drawings, in which:

FIG. 1 shows an automated printing system usable to implement the subject matter of the present disclosure in an exemplary embodiment;

FIG. 2 shows a block diagram of an exemplary electronic control unit;

FIG. 3 shows a view of a GUI screen shot of a print manager having a User TRC tab, according to an embodiment of the present disclosure;

FIG. 4 shows a view of a GUI screen shot of a new TRC Edit/Create window, according to an embodiment of the present disclosure;

FIG. 5 shows a view of a GUI screen shot of control points added with a Dialog Box, according to an embodiment of the present disclosure;

FIG. 6 shows a view of a GUI screen shot of the TRC of FIG. 5 altered to create a new or edited TRC, according to an embodiment of the present disclosure;

FIG. 7 shows a view of a GUI screen shot of selecting a print queue to which a TRC is to be applied with a Dialog Box, according to an embodiment of the present disclosure;

FIG. 8 shows a view of a GUI screen shot of a selected TRC viewed from the queue window path at an automated printing system, according to an embodiment of the present disclosure;

FIG. 9 is a flowchart of an exemplary method of creating a TRC, according to an embodiment of the present disclosure; and

FIG. 10 is a flowchart showing application of a TRC, according to an embodiment of the present disclosure,

### DETAILED DESCRIPTION OF EMBODIMENTS

TRC control for monochrome printers allows users to improve the printed appearance of images (native grayscale) by increasing the contrast of adjacent shaded areas with almost identical density. Due to the TRC control, “washed out” detail is then visible, objects in shadow are distinguishable and some gradients appear smoother. If the density between adjacent shaded areas is too far apart, TRC Control can be used to reduce the tonal range and smooth out abrupt gradient changes or make start contrasts between objects in a picture appear more natural.

In an embodiment, a user may create new TRCs using a tool kit that may be a implemented through a user GUI based tool within the print controller for the creation of TRC files that can be selected at the print queue level for application to PDL print files, such as PostScript™ print files that are submitted to that queue. Users can calibrate controls and manage the TRCs to allow for “fine tuning” the image output. The saved TRCs can also be designated for use by a specific print queue so that users with specific needs or preferences can take advantage of a customized output.

In an exemplary embodiment of the subject matter of the present disclosure, TRC control can comprise of two interdependent elements including a PDL decomposer, such as PostScript™ decomposer and a TRC Control feature that are enabled on the printer controller as part of the base software.

A TRC can be created, named, saved and edited in a “pop-up” window either by dragging control points on the curve or by editing control points in a table. TRCs can also be printed for archival purposes.

Multiple TRCs can also be created and saved and different specific TRCs can be assigned on a queue-by-queue basis. The TRC selection for a given queue can also be changed between print jobs. Because TRC operates at the queue level, the entire print file is affected by any changes to the curve, including all images as well as shaded or colored fonts and lines.

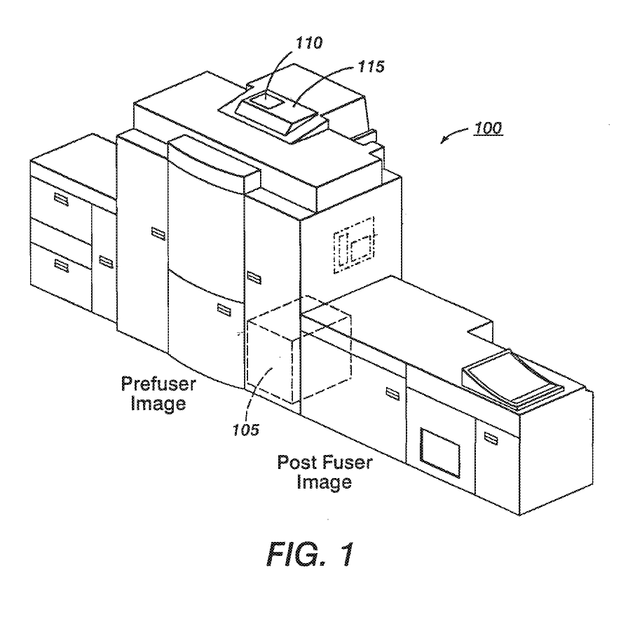

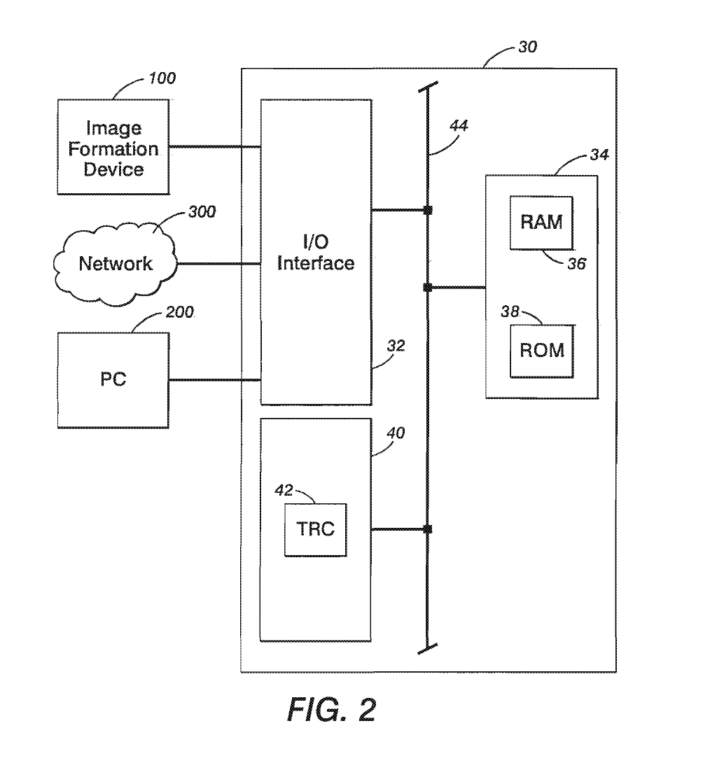

FIG. 1 shows an automated printing system for creating and implementing the subject matter of the present disclosure in an exemplary embodiment. The automated printing system 100 includes a print engine 105, a display 110 and a user input device 115. The automated print system 100 is capable of receiving files to print from customers that, may use different software applications when creating the files. These files often include instructions for creating print pages that require embedded images. An electronic control unit or ECU 30 (FIG. 2) that controls how such files are printed communicates with the automated printing system 100.

FIG. 2 shows a block diagram of an exemplary electronic control unit 30 for controlling how the files are to be printed by providing a tool to allow a user to adjust a TRC to calibrate controls and manage the TRCs to allow for “fine tuning” the image output. As shown in the exemplary embodiment of FIG. 2, the ECU 30 communicates with the automated printing system 100 over a link. The automated printing system 100 may also communicate with one or more user terminals 200 that are local to the automated printing system 100 via a link or at a location remote from, and in communication with the automated printing system 100 via a network 300. Each of the links can be implemented using any known or later developed device or system for connecting the user terminals 200 and the network 300, respectively, to the ECU 30, including a direct cable connection, a connection over a wide area network or a local area network, a connection over an intranet, a connection over the Internet, or a connection over any other distributed processing network or system. In general, each of the links are connected to an I/O interface of the ECU 30 and can be any known or later developed connection system or structure usable to connect the user terminals 200 and the network 300, respectively, to the ECU 30.

Although the exemplary embodiment is described using one or more user terminals 200 separate from the network 300, it should be appreciated that the user terminals 200 may also be in communication with the ECU 30 via the network 300 to transfer files to the automated printing system 100.

The I/O interface 32 of the ECU 30 is connected to a memory 34 that includes a nonvolatile memory portion 38 and a volatile memory portion 36, as well as a print manager 40. The print manager 40 includes TRC creation and implementation feature 42. The I/O interface 32, memory 34 and print manager 40 communicate via a bus 44. The TRC feature 42 may be implemented as a circuit or routine of a suitably programmed general purpose computer. Such circuits or routines may also be implemented as physically distinct hardware circuits within an ASIC, or using a FPGA, a PDL, a PLA or a PAL, or using discrete logic elements or discrete circuit elements. The particular form each such circuit or routine will take is a design choice and will be obvious to those skilled in the art.

The memory 34 can be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writable or re-writeable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

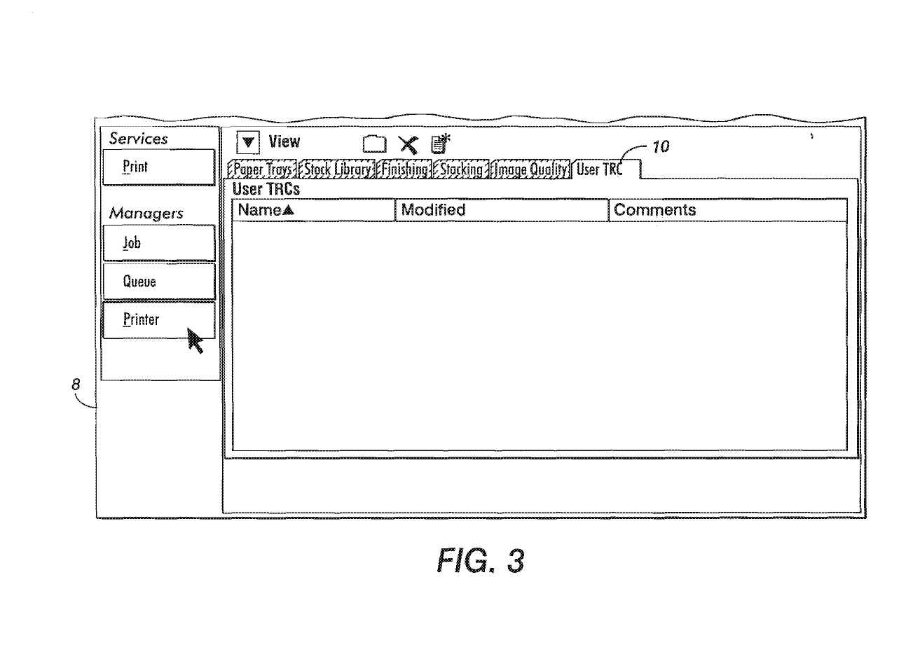

FIG. 3 shows a view of a GUI 8 screen shot representing the print manager 40 having a User TRC tab 10 to provide access to the TRC feature 42, according to an embodiment of the present disclosure. The GUI 8 is displayed on the display 110 of the automated printing system 100. As shown in FIG. 3, within the printer manager 40, the tab 10 entitled “User TRCs” enables the operator to view all custom Tone Reproduction Curves (TRCs), create new TRCs, and view, edit, copy, and delete existing TRCs. A table listing of TRCs can be compiled and sorted by either name or the file modified date by clicking the column heading. Navigation within the GUI 8 may be implemented through the user input device 115.

The TRC graphically relates the “input” grayscale values of the source file and the desired “output” (printed) grayseale values. By adjusting this curve (mapping selected input values to new output values), the file will be printed with tonal ranges that have been broadened or compressed as appropriate. The TRC is applied at print time.

In the embodiment, TRCs may be provided on an image forming device as one or more “factory defined” TRC choices that are supplied to adjust for the more common image file problems. TRCs can also be printed for archival purposes. A print-ready file that has not yet been halftoned can be rendered differently by using TRC Control.

The process of creating a TRC is twofold including creating/adjusting the TRC and attaching the new TRC to a print queue. Using the print manager as shown in FIG. 3, a user selects the User TRC tab 10 using the user input device 115 to enter the appropriate screen and enable the TRC for Monochrome feature 42 of the print manager software application. By activating this feature, the user can improve the printed appearance native grayscale by increasing the contrast of adjacent halftones (shaded areas) with almost identical density. If the density between adjacent shaded areas is too far apart, this feature can also be used to reduce the tonal range. The TRC for Monochrome feature 42 also provides the user with a tool to render otherwise obscure detail more visible, and smooth out abrupt gradient changes, making stark contrasts between objects appear more natural.

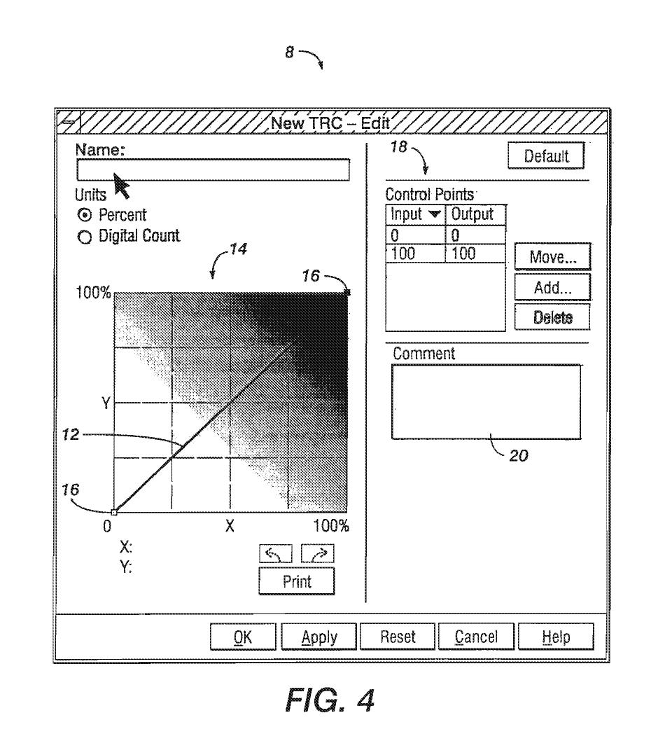

Using a drop-down menu, or other means of selecting the desired function, the user may retrieve a sample TRC from which a new TRC may be created, or an existing TRC may be selected for editing, such as shown in FIG. 4. FIG. 4 shows a view of a GUI 8 screen shot of a TRC create or “new” window according to an embodiment of the present disclosure. Although a “new” window is shown in FIG. 4, the edit window provides essentially the same functionality and capabilities to the user.

In an exemplary embodiment, a TRC can be created, named, saved and edited in a pop-up window either by dragging control points on the curve or by editing control points in a table. When creating a “new” TRC, an “identity” curve 12 displayed in the graph 14 will describe a state in which no gray level change has been made to the gray output levels, i.e. the control points 16 are 0 and 100. The control points 16 define a point on the curve 12 which is being changed. Thus, there may be a plurality of control points 16 on a given TRC. As shown in FIG. 4, the control points 16 for the sample TRC are set at X=0% and Y=100%.

In an exemplary embodiment, the control points 16 may be altered using the Move-Add-Delete 18 features shown in FIG. 4. User comments may also be entered using the “Comments” field 20 to provide descriptive information specific to the TRC. Selection of the Delete feature 18 will reset the curve to the “identity”, or unadjusted, starting identity curve 16.

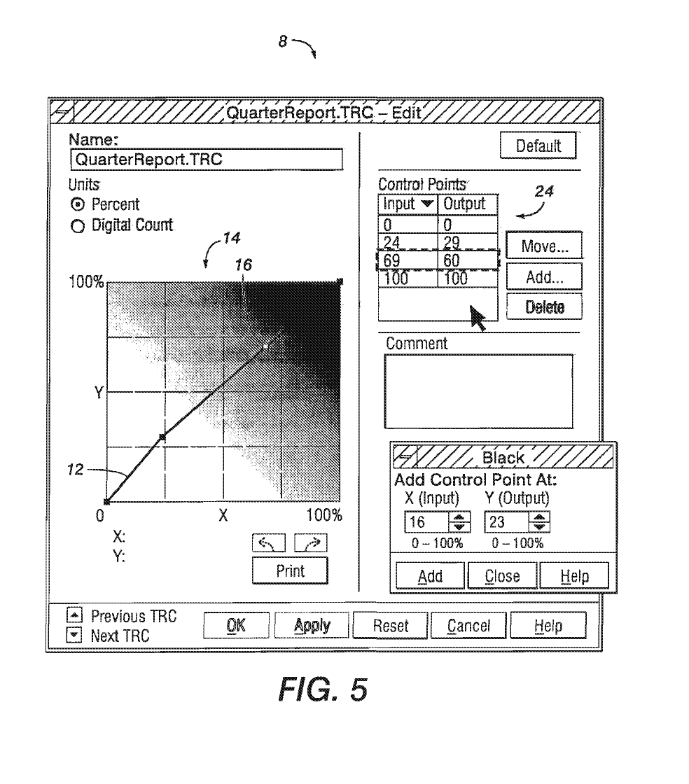

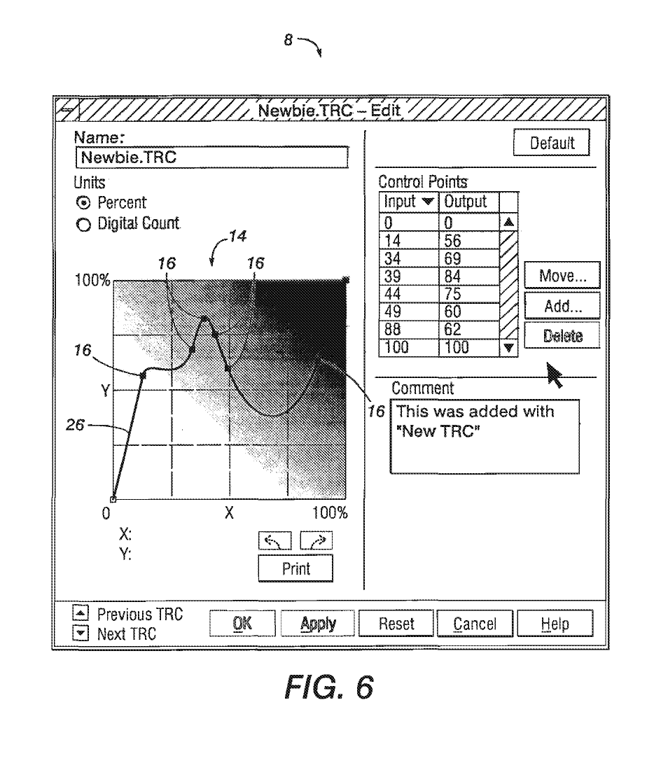

As shown in FIG. 5, the user may begin by entering a name for the new TRC in the “Name” field 22 of the GUI 8. The user may also preferentially select the unit type using the “Unit” select field of the GUI 8. Once selected, all units in the window will adjust accordingly. In an exemplary embodiment, the user can adjust the TRC using a mouse, or other control device, such as a cursor, light pen, touch screen, or the like. The selecting device is positioned on the curve 12 and the point 16 on the curve is “dragged” to its new position to give the curve its desired shape creating a new or edited TRC 26. Control points 16 can also be added, moved, or deleted by selecting a value pair in the “Control Points” field 24 of the GUI 8 as shown in FIGS. 5 and 6. The Control Points field 24 allows target X and Y values to be altered by inputting specific coordinates. A plurality of points 16 may be adjusted to achieve the desired print output creating a unique TRC 26 for a given print queue.

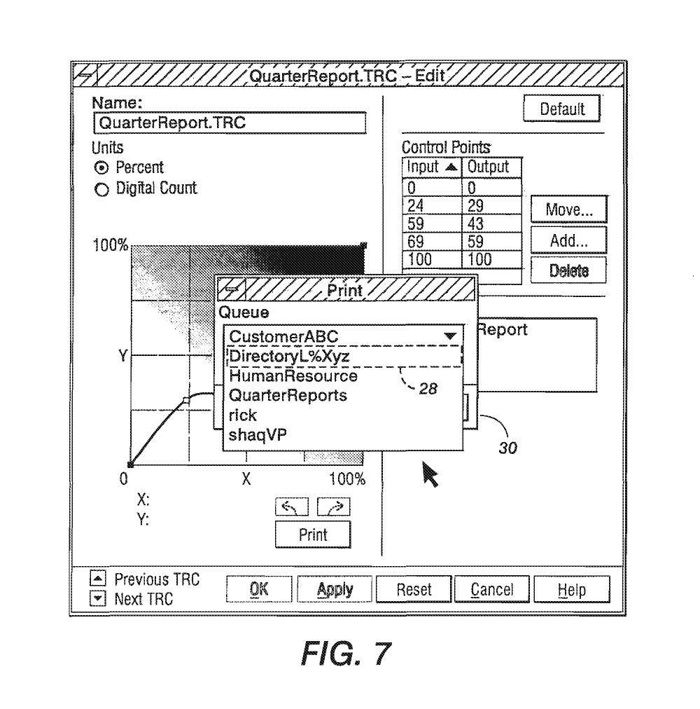

As shown in FIG. 7, upon completion of creating/editing a TRC 26 the user may select a print queue 30 to which the TRC 26 will be applied. In an embodiment, a dialog box, pop-up menu, drop-down menu, or the like may be selected to present optional/available queue fields which enables the user to submit the TRC to any print queue 30.

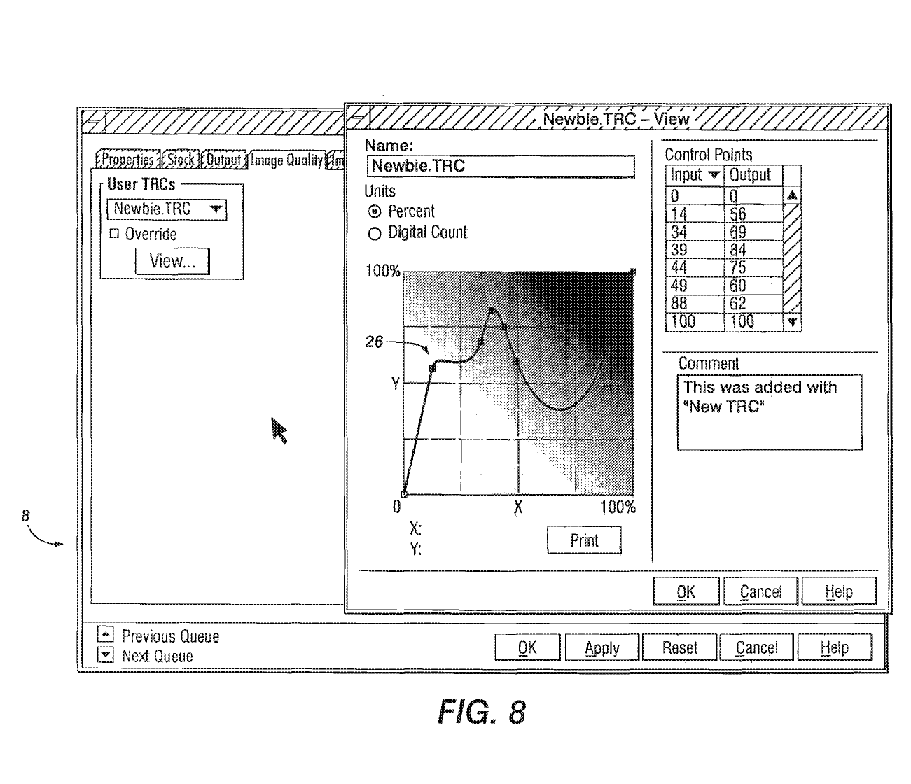

FIG. 8 shows a view of a GUI 8 screen shot of a saved TRC viewed from the queue window path at the display 110 of the automated printing system 100. By enabling a user to view the selected TRC 26 from the display 110 of the automated printing system 100, the TRC 26 may be immediately adjusted to optimize image quality upon viewing the printed image. Once a new or edited TRC is added, the TRC becomes available for selection by each printer queue. In this way a TRC can be selected for a particular print queue for a particular print job and/or set to override the default queue. Multiple TRCs can be saved and different ones assigned on a queue-by-queue basis, Because TRC control operates at the queue level, the entire print file is affected by any changes to the curve including images, as well as shaded fonts and lines.

The TRC alters the grayscale representation of a print file, or print job, by changing the grayscale value within a PDL or PostScript™ file on a pixel-by-pixel basis. In an embodiment, a “settransfer” function array is constructed from the user created TRC. Unlike TRCs created for and used in color image reproduction, TRCs useful for improving the printed appearance of images in native grayscale, i.e., monochrome images, require a method of controlling the grayscale representation of an image within the PDL or PostScript™ file. An exemplary embodiment of the method includes changing the grayscale value, which can be from 0 (black) to 1 (white), on a pixel by pixel basis. In an embodiment, the following settransfer function was defined within each PostScript™ file:

/transarray[
0 0 0 0 1 1 1 1 1 1 1 2 2 2 2 2
2 3 3 3 3 3 3 4 4 4 4 4 5 5 5 5
5 6 6 6 6 6 7 7 7 7 7 8 8 8 8 9
9 9 9 10 10 10 10 11 11 11 11 12 12 12 12 13
13 13 13 14 14 14 15 15 15 15 16 16 16 17 17 17
17 18 18 18 19 19 19 20 20 20 21 21 21 22 22 22
23 23 23 24 24 24 25 25 25 26 26 26 27 27 27 28
28 29 29 29 30 30 30 31 31 32 32 32 33 33 33 34
34 35 35 36 36 36 37 37 38 38 38 39 39 40 40 41
41 41 42 42 43 43 44 44 45 45 45 46 46 47 47 48
48 49 49 50 50 5 51 52 52 53 53 54 54 54 55 55
56 56 57 58 58 59 59 60 60 61 61 62 62 63 63 64
64 65 65 66 66 67 68 68 69 69 70 70 71 71 72 73
73 74 74 75 75 76 77 77 78 78 79 80 80 81 81 82
83 83 84 84 85 86 86 87 87 88 89 89 90 91 91 92
92 93 94 94 95 96 96 97 98 98 99 100 100 100 100 100
]def
{255 mul cvi transarray exch get 100 div
}settransfer

The task of the settransfer function in PostScript™ is to map the grays requested to a set of grays that the PostScript™ interpreter uses for imaging. The array consists of 256 values, one for each of the 256 gray values. For example if gray level 0.5 is requested the transfer function multiplies it by 255 and converts it to an integer, yielding 127. The function looks up the 127^{th} value in the array (33), and divides it by 100, resulting in 0.33 setgray (a 67-percent tint) when the value requested was 0.5. This conversion will make that particular halftone area darker.

The method also includes determining what values to place within the settransfer function. Because the response of the human eye is logarithmic it is much more sensitive to intensity changes between darker grays than the lighter ones. The effect of this phenomenon is that using a simple linear function to produce the numbers produces an image skewed toward the bright end.

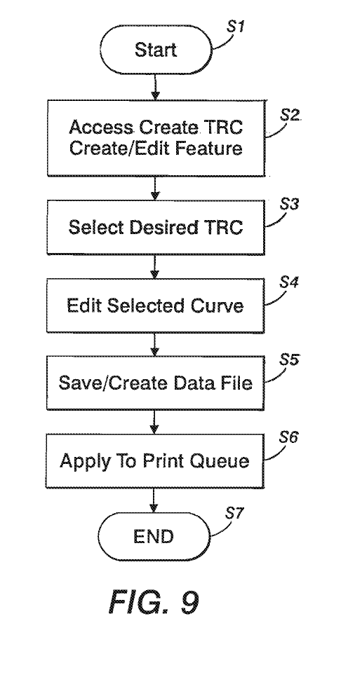

As shown in FIG. 9, an exemplary method of creating a TRC begins at step S1 and continues to step S2 where the proper feature for creating and/or editing a TRC is accessed. Accessing the feature may require a user name and/or password to be entered at a user terminal through a print manager, or the like. Upon accessing the create/edit feature, a TRC is selected at step S3. The selected TRC may be a previously created user TRC that has been assigned to a print queue or an “identity” or new TRC that has not been altered by a user.

After the desired TRC is selected, the process continues to step S4 where the user edits the selected TRC. The editing process may include altering the selected TRC by moving a specific point of the curve to a different set of X, Y coordinates. Moving the specific point may be executed by entering a point along the X and/or Y axis of a graph of the curve or by a “click-and-drag” method whereby a user would select a point along the curve and “drag the point to a new location using a mouse or other similar device. A plurality of points may be adjusted to achieve the desired print output for a given print queue.

Upon completion of the editing process, the revised TRC is saved at step S5 to create a data file representing the adjusted curve. The data file contains a simple encoded description that can be interpreted by the creation/editing tool for further processing later or be used to create the proper settransfer table to be inserted in a PostScript™ file in an additional application. The revised TRC may also be applied to a specific print queue or saved at a memory for future use at step S6. The saved TRCs can also be designated for use by a specific print queue so that users with specific needs or preferences can take advantage of a customized output. The process then ends at step S7.

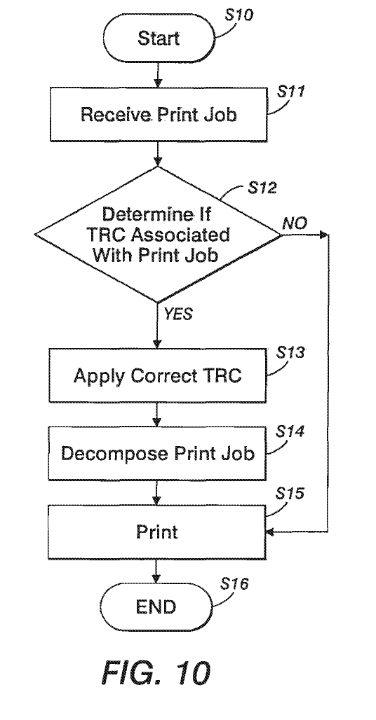

In use, the TRC improves image enhancement by improving the perception of shades of gray to make monochromatic printed images more discernable and appealing upon viewing. In an embodiment, the TRC is applied to a print job at the printer, or other image formation device. As shown in FIG. 10, an exemplary process of the application of a TRC begins at step S10 and continues to step S11 where a print job is received at an image formation device. Upon receipt of the print job, it is determined if the print job includes a TRC label or is otherwise assigned to a particular print queue at step S12. If the print job does not include a TRC designation, the process continues to step S15 where the print job is processed and printed without adjustment associated with a TRC.

If the print job includes a TRC designation, or is otherwise associated with a print queue, the appropriate TRC is applied at step S13. Application of the TRC includes decomposing the print job at step S14 using an algorithm that maps the gray values requested to a set of grays that the PDL or PostScript™ interpreter uses for imaging. Such mapping may include application of a settransfer function that alters the gray value to produce an output that renders otherwise obscure detail more visible, and smoothes out abrupt gradient changes, making stark contrasts between objects appear more natural. The process continues to step S15 where the print job is printed. The process ends at step S16.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. A method for adjusting a printable monochrome image, comprising:
providing a first tonal reproduction curve related to an image file representing a monochrome image;
adjusting the first tonal reproduction curve by altering at least one specific point along the first tonal reproduction curve to a desired location to create a second tonal reproduction curve;
creating a data file of the second tonal reproduction curve;
applying the second tonal reproduction curve to an object in the image file that relies on a page description language decomposer; and
reproducing the monochrome image according to an output of the second tonal reproduction curve.

2. The method according to claim 1, wherein adjusting the first tonal reproduction curve includes altering at least one of an X coordinate and a Y coordinate of the first tonal reproduction curve.

3. The method according to claim 1, wherein creating the data file of the second tonal reproduction curve includes instructions to alter a first grayscale value to a second grayscale value.

4. The method according to claim 3, wherein applying the second tonal reproduction curve includes applying the instructions to alter the first grayscale value to the second grayscale value to the image file of the monochrome image.

5. The method according to claim 1, wherein applying the second tonal reproduction curve includes producing a halftone pattern to simulate a shade of gray different from that of the image file.

6. The method according to claim 1, wherein applying the second tonal reproduction curve includes re-mapping an output of the decomposer from a first output to a second output.

7. The method according to claim 1, wherein the page description language decomposer is a PostScript decomposer.

8. The method according to claim 1, further comprising assigning the second tonal reproduction curve to a print queue.

9. A machine readable medium containing instructions for adjusting a printable monochrome image when the instructions are executed by a processor of an image formation device, comprising:
instructions for adjusting a first tonal reproduction curve by altering at least one specific point along the first tonal reproduction curve to a desired location to create a second tonal reproduction curve;
instructions for creating a data file of the second tonal reproduction curve;
instructions for applying the second tonal reproduction curve to an object in the image file that relies on a page description language decomposer; and
instructions for reproducing the monochrome image according to an output of the second tonal reproduction curve.

10. The machine readable medium according to claim 9, wherein the instructions for adjusting the first tonal reproduction curve includes instructions for altering at least one of an X coordinate and a Y coordinate of the first tonal reproduction curve.

11. The machine readable medium according to claim 9, wherein the instructions for creating the data file of the second tonal reproduction curve includes instructions to alter a first grayscale value to a second grayscale value.

12. The machine readable medium according to claim 9, wherein the instructions for applying the second tonal reproduction curve includes instructions for applying the instructions to alter the first grayscale value to the second grayscale value to the image file of the monochrome image.

13. The machine readable medium according to claim 9, wherein the instructions for applying the second tonal reproduction curve includes instructions for producing a halftone pattern to simulate a shade of gray different from that of the image file.

14. The machine readable medium according to claim 9, wherein the instructions for applying the second tonal reproduction curve includes instructions for re-mapping an output of the decomposer from a first output to a second output.

15. The machine readable medium according to claim 9, wherein the page description language decomposer is a PostScript decomposer.

16. The machine readable medium according to claim 9, further comprising instructions for assigning the second tonal reproduction curve to a print queue.

17. An image formation system for reproducing monochrome images from an electronic data file, comprising:
a display device;
a user input device to alter a first tonal reproduction curve representative image output of an object of the electronic data file;
a print engine; and
an electronic control unit operably connected to the display, the user input device and the print engine, wherein the electronic control unit controls:
adjusting the first tonal reproduction curve by altering at least one specific point along the first tonal reproduction curve to a desired location to create a second tonal reproduction curve;
creating a data file of the second tonal reproduction curve; and
applying the second tonal reproduction curve to an object in the image file that relies on a page description language decomposer to alter the image output of the object of the electronic data file.

18. The image formation system according to claim 16, wherein the image formation system is a xerographic system.
